(19) United States
(12) Patent Application Publication
(10) Pub. No.: US 2021/0344557 A1
(43) Pub. Date: Nov. 4, 2021

(54) SYSTEMS, METHODS, AND APPARATUSES FOR NETWORK MANAGEMENT

(71) Applicant: COMCAST CABLE COMMUNICATIONS, LLC, Philadelphia, PA (US)

(72) Inventors: Nithya Rajagopal, Philadelphia, PA (US); Stephen Allinson, Philadelphia, PA (US); Vijay Anand Selvaraj, Philadelphia, PA (US); Soumya Munshi, Philadelphia, PA (US); Jacob Gladish, Philadelphia, PA (US); Patrick Ladd, Philadelphia, PA (US); David Wong, Philadelphia, PA (US)

(21) Appl. No.: 16/863,752

(22) Filed: Apr. 30, 2020

(51) Int. Cl. H04L 12/24; H04W 12/06; H04W 12/00; H04W 12/08; H04W 84/12

(52) U.S. Cl. CPC H04L 41/0803; H04W 12/06; H04W 84/12; H04W 12/08; H04W 12/003

(57) ABSTRACT

Methods, systems, and apparatuses for network management are described. A network device may provide a network that is accessible using at least one network credential. The network device may receive and/or determine an update to the at least one network credential. The network device may determine that a client device would be prevented from accessing the network without the update to the at least one network credential. The network device may send the update to the at least one network credential to the client device using a secure provisioning protocol.

### BACKGROUND

Wireless networks offer users greater flexibility and connectivity than traditional wired networks. As more devices become Internet-capable, wireless networks have grown in size and complexity. When network credentials for a wireless network are changed, users associated with devices that were previously associated with the wireless network must reconfigure the devices with the new network credentials in order rejoin the wireless network. This can be burdensome for some users and devices. The burden is even greater when a device needing the new network credentials does not have a user interface (e.g., smart devices, Internet-capable appliances, Internet-capable sensors, etc.). Further, existing authentication and configuration methods are less secure than newer methods; however, many Internet-capable devices in use today employ these legacy authentication and configuration methods. These and other considerations are addressed herein.

### SUMMARY

It is to be understood that both the following general description and the following detailed description are exemplary and explanatory only and are not restrictive, as claimed. Methods, systems, and apparatuses for network management are described herein. A network device may generate (e.g., broadcast) a wireless network, such as a WiFi network. In order to access the wireless network, client devices may be required to provide network credentials for the network to the network device. A client device may be, for example, a computing device, a smart device, an Internet-capable appliance, an Internet-capable sensor, etc. The network credentials may include, for example, a network name and a network password. The network device may provide the network credentials to the client device during a configuration session.

Subsequently, the network device may receive updated network credentials. The updated network credentials may include, for example, a new network name (e.g., Service Set Identifier) and/or a new network password. The network device may be reconfigured with the new network credentials such that client devices may be required to provide the updated network credentials to the network device in order to access the network. The client device may attempt, unsuccessfully, to join the network by sending a request to join the network that comprises the network old credentials. The client device may send a reconfiguration message (e.g., a reconfiguration advertisement) to the network device in response to the unsuccessful attempt to join the network.

The reconfiguration message may include a hash of a configuration identifier. The configuration identifier may have been generated by the network device for the client device during a prior configuration session. The network device may receive the reconfiguration message. The network device may send the updated network credentials to the client device as part of a reconfiguration session (e.g., via a secure communication channel). The updated network credentials may be provided to the client device as part of a secure message. The client device may receive the secure message and determine the updated network credentials. The network device may receive a further request to join the network from the client device. The further request to join the network may include the updated network credentials. The network device may determine whether the updated network credentials sent by the client device are valid. The network device may provide the client device with access to the network when it is determined that the updated network credentials are valid.

As another example, the network device may provide the updated network credentials to the client device in response to being reconfigured with the new network credentials (e.g., prior to the client device unsuccessfully attempting to join the network with the old credentials). That is, the network device may initiate a reconfiguration session with the client device after being reconfigured with the new network credentials. The network device may send the updated network credentials to the client device during the reconfiguration session (e.g., via a secure communication channel).

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIGS. 1A and 1B show an example system;

FIGS. 2A-2D show example communication flows;

FIG. 3 shows a flowchart of an example method;

FIG. 4 shows a flowchart of an example method;

FIG. 5 shows a flowchart of an example method;

FIG. 6 shows a flowchart of an example method;

FIG. 7 shows a flowchart of an example method;

FIG. 8 shows a flowchart of an example method; and

FIG. 9 shows a block diagram of an example computing device.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described are components that can be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that can be performed it is understood that each of these additional steps can be performed with any specific embodiment or combination of embodiments of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Methods, systems, and apparatuses for network management are described herein. A network device may generate (e.g., broadcast) a network. The network device may be an access point, a router, a gateway device, one or more thereof, and/or the like. In order to access the network, client devices may be required to provide network credentials for the network to the network device. The network credentials may include, for example, a network name (e.g., Service Set Identifier) and a network password. The client devices may include computing devices, smart devices, set-top boxes, Internet-capable devices, one or more thereof, and/or the like.

A client device may be configured to communicate with the network device during a configuration session. The network device may generate a configuration identifier associated with the network device and the client device during the configuration session. The client device and the network device may use Device Provisioning Protocol (“DPP”), which is a secure provisioning protocol provided by the Wi-Fi Alliance™. For example, the configuration session may be a DPP configuration session.

A user device in communication with the network device may cause the network device to initiate the configuration session with the client device. That is, the user device may initiate the configuration session on behalf of the client device. For example, the user device may be configured to communicate with the network device, while the client device may not be configured to communicate with the network device. The user device may assist the client device in being configured to communicate with the network device. The user device may receive configuration data from the client device. The configuration data may include a Uniform Resource Identifier (“URI”). The URI may represent a public key, a configuration channel, and/or a Media Access Control (“MAC”) address associated with the client device. The URI may be decoded by the user device from an image or other representation of the URI captured by the user device. As another example, the user device may receive the URI from the client device via a message sent by the client device using a wireless interface.

The user device may provide the configuration data to the network device as a configuration payload. The user device may direct the network device to initiate the configuration session with the client device. The network device may receive the configuration payload from the user device. As another example, the network device may receive the configuration payload from the client device in response to a software and/or firmware update performed by the client device. The network device may generate the configuration identifier in response to receiving the configuration payload from the client device (e.g., following the software and/or firmware update performed by the client device).

The network device may generate the configuration identifier. The configuration identifier may be associated with the network device and the client device. For example, the network device may generate a separate configuration identifier for each client device that the network device configures. The network device may initiate the configuration session with the client device. The network device may provide the configuration identifier and the configuration data (e.g., the public key) to the client device during the configuration session. For example, the network device may generate a configuration package (e.g., one or more packets of data) that includes the configuration identifier and the configuration data. The configuration package may identify the client device via the MAC address identified by the URI. The network device may send the configuration package to the client device via the configuration channel identified by the URI during the configuration session.

The network device and/or the client device may use the configuration identifier to determine whether communications received by the network device and/or the client device are legitimate (e.g., originated from a trustworthy source). The network device may provide the network credentials to the client device during the configuration session. For example, the configuration package may include the network credentials. As another example, the network device may send the network credentials to the client device separate from the configuration package (e.g., a separate packet(s) of data) as a secure message. The client device may use the network credentials to join the network generated by the network device.

The network device may receive updated network credentials. For example, the network device may receive an instruction that causes the network device to determine the updated network credentials. The instruction may be received from a client device. As another example, the network device may receive the updated network credentials directly from a client device that has administrative rights to the network device. As a further example, the network device may determine the updated network credentials based on a network rule. The updated network credentials may include, for example, a new network name and/or a new network password. The network device may be reconfigured with the new network credentials such that client devices may be required to provide the updated network credentials to the network device in order to access the network.

The client device may attempt to join the network by sending, to the network device, a request to join the network that comprises the network credentials. The network device may indicate to the client device that the network credentials are not valid. In response to receiving the indication from the network device, the client device may begin listening for a reconfiguration message from the network device. The reconfiguration message may cause the client device to join a reconfiguration session with the network device to receive the updated network credentials. As another example, the client device may send a reconfiguration message (e.g., a reconfiguration advertisement) to the network device. The client device may send the reconfiguration message in response to a determination that the network credentials are not valid.

The client network may receive the reconfiguration message from the network device. The network device may determine whether the reconfiguration message originated from a trusted device. The network device may send a request to initiate a reconfiguration session to the client device. The client device may receive the request from the network device. The network device may initiate the reconfiguration session. The network device may send the updated network credentials to the client device during the reconfiguration session. For example, during the reconfiguration session the network device may send the updated network credentials as part of a connector data structure within a secure message. The client device may receive the secure message and determine the updated access credentials.

As another example, the network device may provide the updated network credentials to the client device in response to being reconfigured with the new network credentials (e.g., prior to the client device unsuccessfully attempting to join the network with the old credentials). The network device may provide the updated network credentials to the client device as a secure message sent via a reconfiguration session (e.g., a secure channel). In response to being reconfigured with the new network credentials, the network device may send a reconfiguration message (e.g., a reconfiguration advertisement) to the client device. The client device may determine whether the reconfiguration message originated from a trusted device. The client device may send a request to the network device to initiate the reconfiguration session. The network device may receive the request and initiate the reconfiguration session. The network device may send the updated network credentials to the client device as a secure message during the reconfiguration session.

The network device may receive a further request to join the network from the client device. The further request to join the network may include the updated network credentials. The network device may determine whether the updated network credentials sent by the client device are valid. The network device may provide the client device with access to the network when it is determined that the updated network credentials are valid.

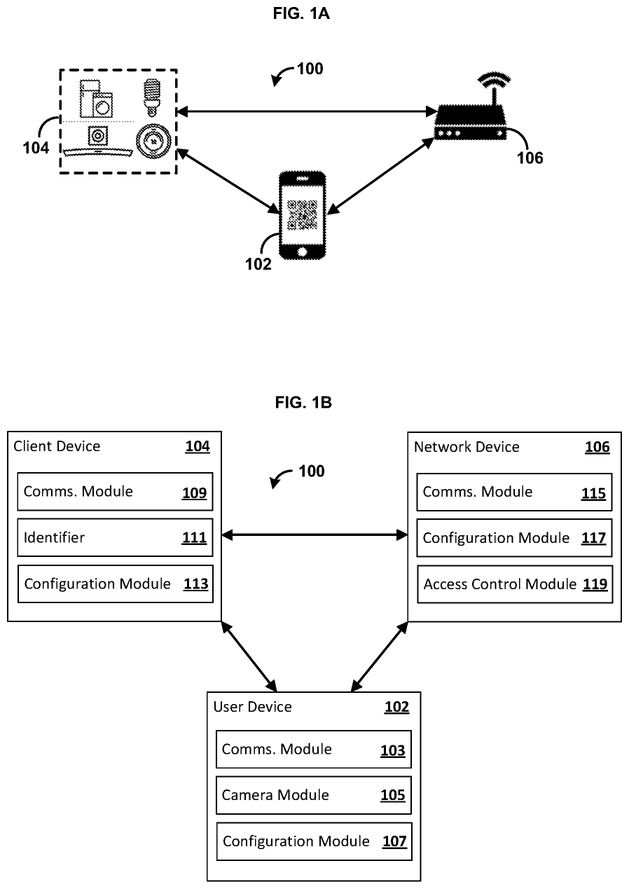

Turning now to FIG. 1A, an example system 100 is shown. The system 100 may include a user device 102, a client device 104, and a network device 106. The network device 106 may provide wired and/or wireless network infrastructure for the system 100. The network device 106 may be an access point, a router, a gateway device, a combination thereof, and/or the like. The user device 102 may be a mobile device, a tablet, a laptop, a desktop, and/or the like. The user device 102 may have been previously configured to communicate with the network device 106 using a device provisioning protocol (“DPP”), which is a secure provisioning protocol provided by the Wi-Fi Alliance™, or a legacy provisioning technique. For example, the user device 102 may have been previously configured to communicate with the network device 106 via a network generated (e.g., broadcast) by the network device 106. The network may operate on one or more 802.11 protocols (e.g., WiFi). The user device 102 may assist in configuring “headless” client devices to communicate with the network device 106. For example, the client device 104 may be a “headless” device that lacks a graphical user interface. The client device 104 may be a computing device, a smart device, a set-top box, an Internet-capable device, a sensor, a light bulb, a camera, an actuator, an appliance, a game controller, audio equipment, one or more thereof, and/or the like. As a “headless” client device 104 may not have an interface for entering network credentials, the user device 102 may communicate with the network device 106 on behalf of the client device 104 in order to provision the client device 104 for communicating with the network device 106.

As another example, the client device 104 may not be a “headless” device. That is, the client device 104 may be computing device comprising a screen/display, such as a mobile device or any other Internet-capable device having a screen/display (e.g., for a graphical user interface). The user device 102 may assist the client device 104 in being configured to communicate with the network device 106. The user device 102 may communicate with the network device 106 on behalf of the client device 104 in order to provision the client device 104 for communicating with the network device 106.

FIG. 1B shows a block diagram illustrating the system 100. The user device 102 may have a communications module 103, a camera module 105, and a configuration module 107. The communications module 103 may be used to send and/or receive communications to/from other devices of the system 100. The communications module 103 may include one or more wireless interfaces, such as an 802.11 radio, a ZigBee radio, a Z-Wave radio, or a Bluetooth™ radio. The camera module 105 may be used to capture images, such as an image located on a client device, on documentation associated with a client device (e.g., a user manual), on packaging associated with a client device (e.g., a box), one or more thereof, and/or the like. The configuration module 107 may include software the user device 102 may use when assisting in configuration of a “headless” client device to communicate with the network device 106. For example, the configuration module 107 may include DPP software and/or legacy provisioning software.

The network device 106 may have a communications module 115, a configuration module 117, and an access control module 119. The communications module 115 may be used to send and/or receive communications to/from other devices of the system 100. The communications module 115 may include one or more wireless interfaces, such as an 802.11 radio, a ZigBee radio, a Z-Wave radio, or a Bluetooth™ radio. The communications module 103 may be used to send and/or receive network communications, such as broadcasting a wireless network and sending/receiving data to/from client devices associated with the network. The configuration module 117 may include software the network device 106 may use when configuring a “headless” client device to communicate with the network device 106. For example, the configuration module 117 may include DPP software and/or legacy provisioning software. The network device 106 may use the configuration module 117 when generating a configuration identifier for a client device during a configuration session. The configuration identifier may be a DPP C-sign-key, which may be a public key associated with the network device 106. The DPP C-sign-key may be part of a key pair along with a DPP c-sign-key. While the DPP C-sign-key may be a public key provided to the client device 104, the DPP c sign-key is a private key used by the network device 106 to sign (e.g., verify authenticity) communications sent to client devices. The access control module 119 may be a secure repository of the network device 106 used to store a client routing table(s), a configuration identifier for each configured client device, a Media Access Control (“MAC”) address(es) for each configured client device, network credentials, etc.

The client device 104 may have a communications module 109, an identifier 111, and a configuration module 113. The communications module 109 may be used to send and/or receive network communications, such as wireless network communications sent to and/or received from the user device 102 and/or the network device 106. The communications module 109 may include one or more wireless interfaces, such as an 802.11 radio, a ZigBee radio, a Z-Wave radio, or a Bluetooth™ radio. Each of the one or more wireless interfaces may have an assigned MAC address. The identifier 111 may be representative of configuration data, such as a Uniform Resource Identifier (“URI”). The URI may represent a public key, a configuration channel, and/or a Media Access Control (“MAC”) address associated with the client device 104. The identifier 111 may be an image may be located on the client device 104, on documentation associated with the client device 104 (e.g., a user manual), on packaging associated with the client device 104 (e.g., a box), one or more thereof, and/or the like. The image may be of a barcode, a Quick Response (“QR”) code, a string of text/numbers, one or more thereof, and/or the like. The client device 104 may provide the identifier 111 to one or both of the user device 102 or the network device 106 via WiFi using the communications module 109. As another example, the client device 104 may provide the identifier 111 to one or both of the user device 102 or the network device 106 via a Bluetooth™ message, a ZigBee message, a Z-Wave message, an NFC message, etc., generated and sent by the communications module 109.

The configuration module 113 may include software the client device 104 may use during a configuration session with one or both of the user device 102 or the network device 106. For example, the configuration module 113 may include DPP software and/or legacy provisioning software. The client device 104 may use the configuration module 113 to decipher and/or validate messages received from the network device 102 as part of a configuration and/or reconfiguration session, such as a hash of a configuration identifier. The client device 104 may use the configuration module 113 to generate a private key in response to receiving the configuration identifier. The client device 104 may use the configuration module 113 to generate a private key associated with the URI. The private key may be used by the client device 104 to decipher messages received from the network device 106 that are secured (e.g., wrapped) using AES-SIV, SHA-256, a combination thereof, and/or the like.

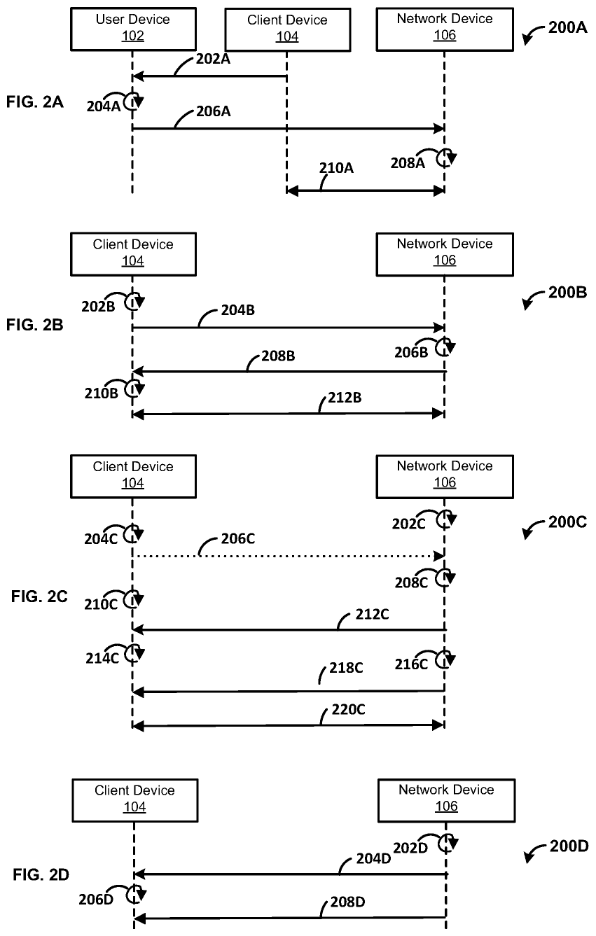

Example functionality of each of the devices of the system 100 will be described with reference to FIGS. 2A-2D each of which shows example communication flows for the system 100. Turning now to FIG. 2A, example communication flows for a configuration process 200A are shown. The configuration process 200A may be employed when initially configuring and/or reconfiguring the client device 104 to communicate with the network device 106. The network device 106 may generate (e.g., broadcast) a network. The network may be a wireless network, such as a WiFi network. In order to access the network, the client device 104 may be required to provide network credentials for the network to the network device 106. The network credentials may include, for example, a network name and a network password.

As discussed herein, the client device 104 may be configured to communicate with the network device 106 during a configuration session. The configuration session may be a DPP configuration session. The user device 102 may initiate the configuration session on behalf of the client device 104. The user device 102 may be in communication with the network device 106. For example, the user device 102 may be in communication with the network device 106 via a first communications protocol and/or a second communications protocol. The first communications protocol may be a Bluetooth™ channel, a ZigBee channel, a Z-Wave channel, a near field communications (“NFC”) channel, or any suitable low-energy and/or short-range communications channel. The second communications protocol may be an 802.11 channel, such as a WiFi channel.

At communication flow 202A, the user device 102 may receive configuration data from the client device 104. The client device 104 may be, as an example, a smart device lacking a graphical user interface for configuring the client device 104. The configuration data may include the identifier 111 of the client device 104. As discussed herein, the identifier 111 may be an image. The user device 102 may capture the identifier 111 using the camera module 105. For example, the user device 102, such as a smartphone or tablet device, may take a snapshot of a QR code associated with the client device 104 (e.g., affixed to the client device 104 or documentation of the client device 104). The QR code may be indicative of the identifier 111 as well as configuration parameters, such as a configuration WiFi channel the client device 104 may be configured to use during a configuration session. As another example, the communications module 103 of the user device 102 may receive the identifier 111 from the client device 104 via a message sent by the client device 104. The message may be sent by the communications module 109 of the client device 104 using WiFi, a Bluetooth™ packet(s), a ZigBee packet(s), a Z-Wave packet(s), an NFC packet(s), etc.

At communication flow 204A, the identifier 111 may be decoded by the user device 102. The identifier 111 may be an image of a URI, a barcode, a QR code, a string of text/numbers, one or more thereof, and/or the like. The identifier 111 may represent a public key, a configuration channel, and/or a MAC address associated with the client device 104. The identifier 111 may be decoded by the user device 102 using the software of the configuration module 107. For example, the user device 102 may be a smartphone or tablet device having software for configuring client devices, such as the client device 104.

At communication flow 206A, the user device 102 may provide the identifier 111 to the network device 106 as a configuration payload. The user device 102 may send the identifier 111 to the network device 106. For example, the user device 102, which may be a smartphone or a tablet device, may send the identifier 111 to the network device 106 via HTTP using a WiFi channel Additionally, at communication flow 206A, the user device 102 may direct the network device 106 to initiate a configuration session with the client device 104. At communication flow 208A, the network device 106 may receive the configuration payload from the user device 102. Additionally, at communication flow 208A, the network device 106 may generate a configuration identifier (e.g., in response to receiving the configuration payload from the user device 102). The configuration identifier may be associated with the network device 106.

At communication flow 210A, the network device 106 may initiate the configuration session with the client device 104. The network device 106 may provide the configuration identifier and the identifier 111 (e.g., the public key) to the client device 104 during the configuration session. For example, the network device 106 may generate a configuration package (e.g., one or more packets of data) that includes the identifier 111 and the configuration identifier. The configuration package may identify the client device 104 via the MAC address identified by the identifier 111. The configuration package may be encrypted using the public key identified by the URI. The network device 106 may send the configuration package to the client device 104 via the configuration channel identified by the identifier 111 during the configuration session. The network device 106 may be, for example, a network gateway/router, and the configuration channel may be a secure WiFi channel.

When providing the configuration identifier and the identifier 111 (e.g., the public key) to the client device 104 during the configuration session as part of the configuration package, the network device 106 may hash the configuration identifier and/or the identifier 111 and secure other contents of the configuration package (e.g., wrap the contents). For example, the network device 106 may provide a hash of the configuration identifier and/or a hash of the identifier 111 to the client device 104 as part of the configuration package. The client device 104 may receive the hash of the configuration identifier and/or the hash of the identifier 111 using the communications module 109.

The client device 104 may generate a private key associated with the configuration identifier. The client device 104 may store the private key associated with the configuration identifier in the configuration module 113. In this way, the client device 104 may receive secured (e.g., wrapped) communications and decipher the contents thereof. For example, the client device 104 may receive the configuration package and determine whether the sender of the configuration package (e.g., the network device 106) is a trusted device. The client device 104 may determine that the network device 106 is a trusted device based on hashing the configuration identifier previously provided by the network device 106 and comparing the result to the hash of the configuration identifier and/or a hash of the identifier 111 provided with the configuration package. Additionally, at communication flow 210A, the network device may provide the network credentials to the client device 104 during the configuration session. For example, the configuration package may include the network credentials as part of a secure message. The client device 104 may decipher the secured message to determine the network credentials using the previously generated private key.

As described herein, the client device 104 may be, as an example, a smart device lacking a graphical user interface for configuring the client device 104; the user device 102 may be, for example, a mobile device; and the network device 106 may be, for example, a router. Accordingly, the communication flows described in FIG. 2A may allow the router to configure and/or reconfigure the smart device to communicate with the router via the network broadcast by the router. For example, the configuration process 200A may be employed when initially configuring and/or reconfiguring the smart device to communicate with the router via the network (e.g., a WiFi network). The mobile device may act as an intermediary between the router and the smart device in order to assist in provisioning and/or re-provisioning the smart device. The mobile device may determine the identifier 111 as well as configuration parameters as described above and send the identifier 111 and configuration parameters to the router. In this way, the mobile device may cause the router to begin a configuration session with the smart device. The router may receive the identifier 111 and the configuration parameters and subsequently being communicating with the smart device via a secure provisioning channel (e.g., the configuration channel/secure WiFi channel described herein). The router may provide the smart device with network credentials, such as a network name and/or network password, via the secure provisioning channel. The smart device may then join the network broadcast by the router using the network credentials.

Turning now to FIG. 2B, example communication flows for a configuration process 200B are shown. The configuration process 200B may be employed when the client device 104 was previously configured to communicate with the network device 106 using a legacy configuration technique and the client device subsequently becomes DPP-capable. The network device 106 may be, for example, a network gateway/router. At communication flow 202B, the client device 104 may perform a software and/or firmware update to become DPP-capable. The client device 104 may be, as an example, a smart device lacking a graphical user interface for configuring the client device 104. As part of the software and/or firmware update, the client device 104 may receive and/or install DPP provisioning software in the configuration module 113. At communication flow 204B, the client device 104 may send a request for a configuration identifier to the network device 106. The client device 104 may send the request for a configuration identifier using the communications module 109. The request for the configuration identifier may be sent to the network device 106 as a configuration payload. The configuration payload may include the identifier 111.

At communication flow 206B, the network device 106 may generate a configuration identifier using the configuration module 117. The network device 106 may generate the configuration identifier in response to receiving the request for the configuration identifier from the client device 104 (e.g., following the software and/or firmware update performed by the client device 104). The network device 106 may store the configuration identifier and/or the configuration payload in the access control module 119. The configuration identifier may be associated with the network device 106.

At communication flow 208B, the network device 106 may use the communications module 115 to send the configuration identifier and the identifier 111 (e.g., the public key) to the client device 104. For example, the network device 106 may use the configuration module 117 to generate a configuration package (e.g., one or more packets of data) that includes the identifier 111 and the configuration identifier. The configuration package may identify the client device 104 via the MAC address identified by the identifier 111. The network device 106 may send the configuration package to the client device 104 via the configuration channel identified by the identifier 111. The configuration channel may be a WiFi channel.

When providing the configuration identifier and the identifier 111 (e.g., the public key) to the client device 104, the network device 106 may hash the configuration identifier and/or the identifier 111. For example, the network device 106 may use the communications module 115 to provide a hash of the configuration identifier and/or a hash of the identifier 111 to the client device 104. At communication flow 210B, the client device 104 may receive the hash of the configuration identifier and/or the hash of the identifier 111 using the communications module 109. The client device 104 may determine whether the hash of the configuration identifier and/or the hash of the identifier 111 originated from the network device 106 by hashing the configuration identifier previously provided by the network device 106 and comparing the result to the hash of the configuration identifier and/or a hash of the identifier 111 sent by the network device at communication flow 210B.

At communication flow 212B, the network device 106 may use the configuration module 117 to initiate a configuration session and to communicate with the client device 104 using the communications module 115. The network device 106 may provide network credentials to the client device 104 during the configuration session using the communications module 115. For example, the network device 106 may send updated network credentials to the client device 104 that replace existing network credentials stored at the client device 104. The updated network credentials may be provided to the client device 104 as a connector data structure as described herein. It should be noted that the network device 106 may not initiate a configuration session with the client device 104 at communication flow 212B if the existing network credentials have not been updated/changed.

As described herein, the client device 104 may be, as an example, a smart device lacking a graphical user interface for configuring the client device 104 and the network device 106 may be, for example, a router. Accordingly, the communication flows described in FIG. 2B may allow the router to configure and/or reconfigure the smart device to communicate with the router. For example, the configuration process 200B may be employed when the smart device was previously configured to communicate with the router using a legacy configuration technique and the smart device subsequently becomes DPP-capable. The smart device may have been DPP-capable initially when it was previously configured using the legacy configuration technique. The smart device may subsequently perform a software and/or firmware update to become DPP-capable and send a request to the router to begin a DPP configuration session. The router may receive the request from the smart device and initiate a DPP configuration session with the smart device using a secure provisioning channel (e.g., the configuration channel/secure WiFi channel described herein). The router may provide the smart device with network credentials via the DPP configuration session, such as a network name and/or network password, via the secure provisioning channel.

Turning now to FIG. 2C, example communication flows for a configuration process 200C are shown. The configuration process 200C may be employed when the client device 104 was previously configured to communicate with the network device 106 using DPP (e.g., as part of the configuration process 200A or 200B) and the existing network credentials are updated/changed. At communication flow 202C, the network device 106 may receive updated network credentials. For example, the network device 106 may receive an instruction via the communications module 115 that causes the network device 106 to determine the updated network credentials using the access control module 119. The instruction may be received from a client device other than the client device 104. As another example, the network device 106 may receive the updated network credentials directly from a client device other than the client device 104 that has administrative rights to the network device 106. As a further example, the network device 106 may determine the updated network credentials using the access control module 119 based on a network rule. The network rule may cause the access control module 119 to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The network device 106 may use the communications module 115 to regenerate (e.g., broadcast) the network such that client devices may be required to provide the updated network credentials to the network device 106 in order to access the network.

At communication flow 204C, the client device 104 may lose communication with the network device 106. For example, the client device 104 may be rebooted such that communication with the network device 106 is lost. As another example, the client device 104 may change position relative to the network device 106 such that communication with the network device 106 is lost. As a further example, communication between the client device 104 and the network device 106 may be lost by virtue of the network credentials being updated. At communication flow 206C, which may optionally be performed, the client device may attempt to rejoin the network by sending, to the network device 106 via the communications module 109, a request to join the network including the existing network credentials. The client device 104 may send the request to join the network via the second communications protocol (e.g., via WiFi). At communication flow 208C, the network device 106 may determine that the client device 104 may be prevented from accessing the network generated by the network device 106 without the updated network credentials. For example, the network device 106 may determine that client device 104 attempted to rejoin the network using invalid network credentials. The network device 106 may indicate to the client device that the network credentials provided with the request are not valid. At communication flow 210C, which may occur at or substantially near a same time as the communication flow 208C, the client device 104 may begin listening for a reconfiguration message (e.g., a reconfiguration advertisement). The client device 104 may begin listening for the reconfiguration message in response to receiving the indication from the network device 106 that the network credentials provided with the request are not valid. The client device 104 may listen for the reconfiguration message using the communications module 109 and the first communications protocol.

At communication flow 212C, the network device 106 may send a reconfiguration message (e.g., a reconfiguration advertisement) to the client device 104. For example, the network device 106 may use the configuration module 117 to generate a reconfiguration message (e.g., a reconfiguration advertisement) (e.g., one or more packets of data) that includes the configuration identifier previously generated by the network device 106 during a prior configuration session and/or the identifier 111 previously received by the network device 106 during a prior configuration session. The reconfiguration message may identify the client device 104 via the MAC address identified by the identifier 111. The network device 106 may send the reconfiguration message to the client device 104 via the configuration channel identified by the identifier 111. The network device 106 may send the reconfiguration message via the first communications protocol. The network device 106 may send the reconfiguration message in response to a determination that the network credentials provided by the client device 104 at the communication flow 206C are not valid.

At communication flow 214C, the client device 104 may receive the reconfiguration message from the network device 106. When providing the reconfiguration message, the network device 106 may encrypt the configuration identifier and/or the identifier 111. For example, the network device 106 may provide the reconfiguration message and a hash of the configuration identifier and/or a hash of the identifier 111 to the client device 104. The client device 104 may receive the reconfiguration message and the hash of the configuration identifier and/or the hash of the identifier 111 using the communications module 109.

The client device 104 may have a private key stored in the configuration module 113 that corresponds to the identifier 111. The client device 104 may use the private key that corresponds to the identifier 111 to decrypt the hash of the identifier 111. The client device 104 may have a private key stored in the configuration module 113 that corresponds to the configuration identifier. The client device 104 may use the private key that corresponds to the configuration identifier to decrypt the hash of the configuration identifier. In this way, the client device 104 may receive the reconfiguration message (e.g., along with the hash of the configuration identifier and/or the hash of the identifier 111) and determine whether the sender of the reconfiguration message (e.g., the network device 106) is a trusted device. For example, the client device 104 may determine that the network device 106 is a trusted device based on the hash of the configuration identifier—once decrypted using the private key associated with the configuration identifier—including the configuration identifier. As another example, the client device 104 may determine that the network device 106 is a trusted device based on the hash of the identifier 111—once decrypted using the private key associated with the identifier 111—including the identifier 111.

At communication flow 216C, the network device 106 may generate a new configuration identifier (e.g., as part of a DPP C-sign-key and c-sign-key key pair) for the network device 106 using the configuration module 117. The new configuration identifier may be stored in the access control module 119 of the network device 106. The network device 106 may generate the new configuration identifier in response to sending the reconfiguration message (e.g., in response to beginning a reconfiguration process with the client device 104). At communication flow 218C, the network device 106 may send the new configuration identifier to the client device 104 using the communications module 115. The client device 104 may receive the new configuration identifier and store it in the configuration module 113. The client device 104 may use the configuration module 113 to generate a new private key associated with the new configuration key. The client device 104 may store the new private key in the configuration module 113. At communication flow 220C, the network device 106 may initiate a reconfiguration session with the client device 104. Additionally, or in the alternative, the client device 104 may send a request to initiate the reconfiguration session to the network device 106. The reconfiguration session may be a DPP session. The network device 106 may send the updated network credentials to the client device 104 during the reconfiguration session via the first communications protocol.

Also at communication flow 220C, the network device 106 may receive a further request to join the network from the client device 104. The client device 104 may send the further request to join the network via the second communications protocol (e.g., via WiFi). The further request to join the network may include the updated network credentials. The network device 104 may determine whether the updated network credentials sent by the client device 104 are valid. The network device 106 may provide the client device 104 with access to the network when it is determined that the updated network credentials are valid.

As described herein, the client device 104 may be, as an example, a smart device lacking a graphical user interface for configuring the client device 104 and the network device 106 may be, for example, a router. As another example, the client device 104 may not be a “headless” device. That is, the client device 104 may be computing device comprising a screen/display, such as a mobile device or any other Internet-capable device having a screen/display (e.g., for a graphical user interface). Accordingly, the communication flows described in FIG. 2C may allow the smart device to receive updated network credentials, such as a network name and/or network password, via a secure provisioning channel when current network credentials are changed. For example, the configuration process 200C may be employed when the smart device was previously configured to communicate with the router using DPP (e.g., as part of the configuration process 200A or 200B) and the existing network credentials are updated/changed. The network credentials may be changed by the router itself, or the network credentials may be changed by another device with administrative rights in communication with the router. The smart device may attempt to join the network broadcast by the router using existing network credentials the smart device previously received. The smart device may be denied access to the network based on the existing network credentials being invalid (e.g., the router may indicate to the smart device that the network credentials are invalid). The smart device may send a request to the router to initiate a DPP configuration session to enable the smart device to receive the updated network credentials. The router may receive the request from the smart device and initiate a DPP configuration session with the smart device using a secure provisioning channel (e.g., the configuration channel/secure WiFi channel described herein). The router may provide the smart device with the updated network credentials via the DPP configuration session. The smart device may subsequently join the network using the updated network credentials.

Turning now to FIG. 2D, example communication flows for a configuration process 200D are shown. The configuration process 200D may be employed when the client device 104 was previously configured to communicate with the network device 106 and the existing network credentials are updated/changed. At communication flow 202D, the network device 106 may receive updated network credentials. For example, the network device 106 may receive an instruction via the communications module 115 that causes the network device 106 to determine the updated network credentials using the access control module 119. The instruction may be received from a client device other than the client device 104. As another example, the network device 106 may receive the updated network credentials directly from a client device other than the client device 104 that has administrative rights to the network device 106. As a further example, the network device 106 may determine the updated network credentials using the access control module 119 based on a network rule. The network rule may cause the access control module 119 to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The network device 106 may use the communications module 115 to regenerate (e.g., broadcast) the network such that client devices may be required to provide the updated network credentials to the network device 106 in order to access the network.

Also at communication flow 202D, the network device 106 determine that the client device 104 may be prevented from accessing the network generated by the network device 106 without the updated network credentials. For example, the network device 106 may determine that client device 104 attempted to rejoin the network using invalid network credentials. The network device 106 may indicate to the client device that the network credentials provided with the request are not valid.

At communication flow 204D, the network device 106 may send a reconfiguration message (e.g., a reconfiguration advertisement) to the client device 104. For example, the network device 106 may use the configuration module 117 to generate a reconfiguration message (e.g., a reconfiguration advertisement) (e.g., one or more packets of data) that includes a configuration identifier previously generated by the network device 106 during a prior configuration session and/or the identifier 111 previously received by the network device 106 during a prior configuration session. The reconfiguration message may identify the client device 104 via the MAC address identified by the identifier 111. The network device 106 may send the reconfiguration message to the client device 104 via the configuration channel identified by the identifier 111. The network device 106 may send the reconfiguration message via the first communications protocol. The network device 106 may send the reconfiguration message in response to a determination that the network credentials provided by the client device 104 are not valid.

At communication flow 206D, the client device 104 may receive the reconfiguration message from the network device 106. When providing the reconfiguration message, the network device 106 may encrypt the configuration identifier and/or the identifier 111. For example, the network device 106 may provide the reconfiguration message and a hash of the configuration identifier and/or a hash of the identifier 111 to the client device 104. The client device 104 may receive the reconfiguration message and the hash of the configuration identifier and/or the hash of the identifier 111 using the communications module 109.

The client device 104 may have a private key stored in the configuration module 113 that corresponds to the identifier 111. The client device 104 may use the private key that corresponds to the identifier 111 to decrypt the hash of the identifier 111. The client device 104 may have a private key stored in the configuration module 113 that corresponds to the configuration identifier. The client device 104 may use the private key that corresponds to the configuration identifier to decrypt the hash of the configuration identifier. In this way, the client device 104 may receive the reconfiguration message (e.g., along with the hash of the configuration identifier and/or the hash of the identifier 111) and determine whether the sender of the reconfiguration message (e.g., the network device 106) is a trusted device. For example, the client device 104 may determine that the network device 106 is a trusted device based on the hash of the configuration identifier—once decrypted using the private key associated with the configuration identifier—including the configuration identifier. As another example, the client device 104 may determine that the network device 106 is a trusted device based on the hash of the identifier 111—once decrypted using the private key associated with the identifier 111—including the identifier 111.

The network device 106 may generate a new configuration identifier (e.g., as part of a DPP C-sign-key and c-sign-key key pair) for the network device 106 using the configuration module 117. The new configuration identifier may be stored in the access control module 119 of the network device 106. The network device 106 may generate the new configuration identifier in response to sending the reconfiguration message (e.g., in response to beginning a reconfiguration process with the client device 104). The network device 106 may send the new configuration identifier to the client device 104 using the communications module 115. The client device 104 may receive the new configuration identifier and store it in the configuration module 113. The client device 104 may use the configuration module 113 to generate a new private key associated with the new configuration key. The client device 104 may store the new private key in the configuration module 113.

At communication flow 208D, the network device 106 may initiate a reconfiguration session with the client device 104. Additionally, or in the alternative, the client device 104 may send a request to initiate the reconfiguration session to the network device 106. The reconfiguration session may be a DPP session. The network device 106 may send the updated network credentials to the client device 104 during the reconfiguration session. For example, the network device 106 may send the updated network credentials to the client device 104 during the reconfiguration session via the first communications protocol. The network device 106 may receive a further request to join the network from the client device 104. The client device 104 may send the further request to join the network via the second communications protocol (e.g., via WiFi). The further request to join the network may include the updated network credentials. The network device 104 may determine whether the updated network credentials sent by the client device 104 are valid. The network device 106 may provide the client device 104 with access to the network when it is determined that the updated network credentials are valid.

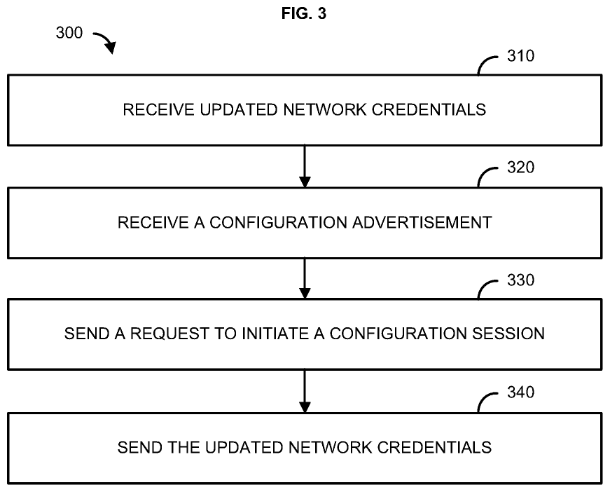

FIG. 3 is a flowchart illustrating an example method 300 for network management. The method 300 may be implemented using the devices of the system 100. For example, the method 300 may be implemented by a first computing device, such as the network device 102. The method 300 may be implemented by the first computing device when a second computing device needs to be reconfigured. The second computing device may be a client device that was previously configured (e.g., as part of the configuration process 200A or 200B) to communicate with a network generated by a first computing device. The second computing device may have been previously configured to communicate with the network using device provision protocol (“DPP”). The second computing device may need to be reconfigured with updated network credentials when at least one existing network credential for the network is updated/changed. The at least one network credential may be, for example, a new network name (e.g., Service Set Identifier) and/or a new network password.

At step 310, a first computing device (e.g., a network device) may receive updated network credentials. For example, the first computing device may receive an instruction that causes the first computing device to determine the updated network credentials. The instruction may be received from a client device. As another example, the first computing device may receive the updated network credentials directly from a client device that has administrative rights to first computing device. As a further example, the first computing device may determine the updated network credentials based on a network rule. The network rule may cause the first computing device to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The first computing device may be reconfigured with the new network credentials such that client devices may be required to provide the updated network credentials to the first computing device in order to access the network.

A second computing device, such as a client device, may lose communication with the network. The second computing device may have been previously configured to communicate with the network using network credentials that are no longer valid. The second computing device may attempt to rejoin the network by sending, to the first computing device, a request to join the network that comprises invalid network credentials. The first computing device may determine that second computing device attempted to rejoin the network using invalid network credentials. The first computing device may indicate to the second computing device that the network credentials provided with the request are not valid. The second computing device may begin listening for a reconfiguration message. For example, the second computing device may begin listening for the reconfiguration message in response to receiving the indication from the first computing device that the network credentials provided with the request are not valid. The reconfiguration message may cause the second computing device to join a reconfiguration session with the first computing device to receive the updated network credentials. As another example, the second computing device may send a reconfiguration message (e.g., a reconfiguration advertisement) to the first computing device.

At step 320, the first computing device may receive a configuration advertisement. For example, the second computing device may send a reconfiguration message (e.g., a reconfiguration advertisement) to the first computing device. The second computing device may generate a reconfiguration message (e.g., a reconfiguration advertisement) (e.g., one or more packets of data) that includes a configuration identifier previously received by the second computing device during a prior configuration session and/or configuration data previously received by the second computing device during a prior configuration session. The configuration data may include a Uniform Resource Identifier (“URI”). The URI may represent a public key, a configuration channel, and/or a Media Access Control (“MAC”) address associated with the second computing device. The reconfiguration message may identify the second computing device via the MAC address identified by the configuration data. The second computing device may send the reconfiguration message to the first computing device via the configuration channel identified by the configuration data. The second computing device may send the reconfiguration message via a WiFi channel. The second computing device may send the reconfiguration message in response to an unsuccessful attempt to join the network using network credentials that are no longer valid.

The first computing device may receive the reconfiguration message from the second computing device. When providing the reconfiguration message, the second computing device may hash the configuration identifier and/or the configuration data. For example, the second computing device may provide the reconfiguration message and a hash of the configuration identifier and/or a hash of the configuration data to the first computing device.

The first computing device may determine whether the sender of the reconfiguration message (e.g., the second computing device) is a trusted device. For example, the first computing device may determine that the second computing device is a trusted device based on the hash of the configuration identifier corresponding to a result of hashing the first computing device's own configuration identifier.

At step 330, the first computing device may send a request to initiate a reconfiguration session with the second computing device. The first computing device may initiate the reconfiguration session with the second computing device. The reconfiguration session may be a DPP session. At step 340, the first computing device may send the updated network credentials to the second computing device. For example, the first computing device may send the updated network credentials to the second computing device during the reconfiguration session (e.g., via a WiFi channel).

The first computing device may receive a further request to join the network from the second computing device. The second computing device may send the further request to join the network via WiFi. The further request to join the network may include the updated network credentials. The first computing device may determine whether the updated network credentials sent by the second computing device are valid. The first computing device may provide the second computing device with access to the network when it is determined that the updated network credentials are valid.

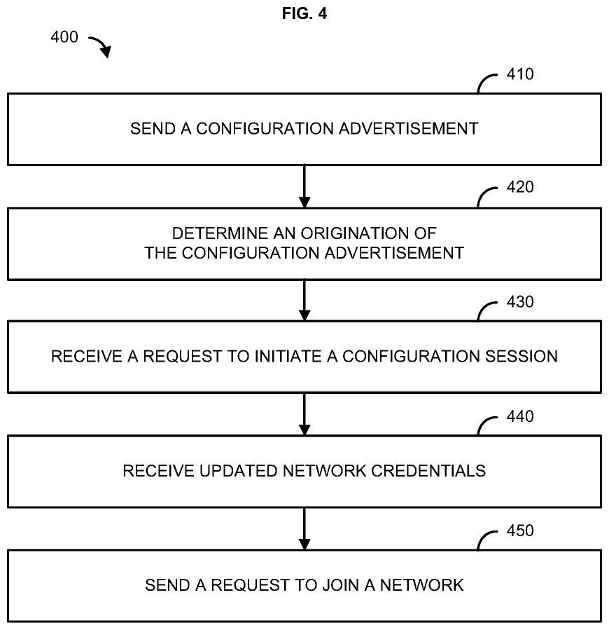

FIG. 4 is a flowchart illustrating an example method 400 for network management. The method 400 may be implemented using the devices of the system 100. For example, the method 400 may be implemented by a first computing device, such as the client device 104, when the first computing device needs to be reconfigured. The first computing device may have been previously configured (e.g., as part of the configuration process 200A or 200B) to communicate with a network generated by a second computing device, such as the network device 106. The first computing device may have been previously configured to communicate with the network using device provision protocol (“DPP”). The first computing device may need to be reconfigured with updated network credentials when at least one existing network credential for the network is updated/changed. The at least one network credential may be, for example, a new network name (e.g., Service Set Identifier) and/or a new network password.

The second computing device may receive updated network credentials. For example, the second computing device may receive an instruction that causes the second computing device to determine the updated network credentials. The instruction may be received from a third computing device, such as another client device in communication with the second computing device. The third computing device may have administrative rights to the second computing device (e.g., enabling the third computing device to update/change the network credentials). As a further example, the second computing device may determine the updated network credentials based on a network rule. The network rule may cause the second computing device to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The second computing device may be reconfigured with the new network credentials such that client devices may be required to provide the updated network credentials to the second computing device in order to access the network.

The first computing device, such as a client device, may lose communication with the network. The first computing device may have been previously configured to communicate with the network using network credentials that are no longer valid. The first computing device may attempt to rejoin the network by sending, to the second computing device, a request to join the network that comprises invalid network credentials. The second computing device may determine that the first computing device attempted to rejoin the network using invalid network credentials. The second computing device may indicate to the first computing device that the network credentials provided with the request are not valid. The first computing device may begin listening for a reconfiguration message (e.g., a reconfiguration advertisement). For example, the first computing device may begin listening for the reconfiguration message in response to receiving the indication from the second computing device that the network credentials provided with the request are not valid.

At step 410, the first computing device may send a reconfiguration message (e.g., a reconfiguration advertisement) to the second computing device. For example, the first computing device may generate a reconfiguration message (e.g., a reconfiguration advertisement) (e.g., one or more packets of data) that includes a hash of a configuration identifier previously generated by the second computing device during a prior configuration session and/or a hash of configuration data previously received by the second computing device during a prior configuration session. The configuration data may include a Uniform Resource Identifier (“URI”). The URI may represent a public key, a configuration channel, and/or a Media Access Control (“MAC”) address associated with the first computing device. The reconfiguration message may identify the first computing device via the MAC address identified by the configuration data. The first computing device may send the reconfiguration message to the second computing device via the configuration channel identified by the configuration data. The first computing device may send the reconfiguration message in response to a determination that the network credentials provided by the second computing device are not valid. When sending the reconfiguration message, the first computing device may hash the configuration identifier and/or the configuration data. For example, the first computing device may provide the reconfiguration message and a hash of the configuration identifier and/or a hash of the configuration data to the second computing device.

At step 420, the second computing device may determine an origination of the reconfiguration message. The second computing device may compare a result of hashing its own configuration identifier to the hash of the configuration identifier and/or the hash of the configuration data sent by the first computing device. In this way, the second computing device may receive the reconfiguration message and determine whether the sender of the reconfiguration message (e.g., the first computing device) is a trusted device.

The second computing device may generate a new configuration identifier (e.g., as part of a DPP C-sign-key and c-sign-key key pair) for the first computing device. The second computing device may generate the new configuration identifier in response to receiving the reconfiguration message (e.g., in response to beginning a reconfiguration process with the first computing device). The second computing device may send the new configuration identifier to the first computing device. The first computing device may generate a new private key associated with the new configuration key. The first computing device may store the new private key in the configuration module.

At step 430, the second computing device may send a request to initiate a reconfiguration session to the first computing device. The second computing device may initiate the reconfiguration session with the first computing device. The reconfiguration session may be a DPP session. At step 440, the first computing device may receive the updated network credentials from the second computing device. For example, the second computing device may send the updated network credentials to the first computing device during the reconfiguration session via a WiFi channel.

At step 450, the first computing device may send a further request to join the network to the second computing device. The first computing device may send the further request to join the network via WiFi. The further request to join the network may include the updated network credentials. The second computing device may determine whether the updated network credentials sent by the first computing device are valid. The second computing device may provide the first computing device with access to the network when it is determined that the updated network credentials are valid.

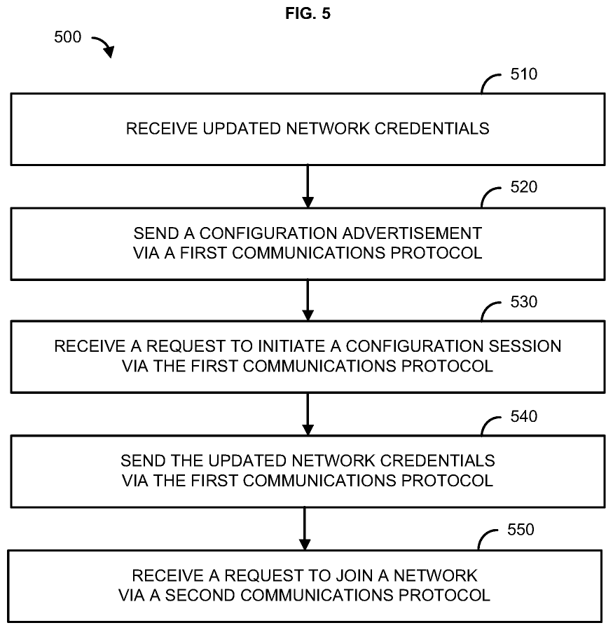

FIG. 5 is a flowchart illustrating an example method 500 for network management. The method 500 may be implemented using the devices of the system 100. For example, the method 500 may be implemented by a first computing device, such as the network device 106. The method 500 may be implemented by the first computing device when a second computing device, such as the client device 104, needs to be reconfigured. The second computing device may have been previously configured (e.g., as part of the configuration process 200A or 200B) to communicate with a network generated by the first computing device. The second computing device may have been previously configured to communicate with the network using device provision protocol (“DPP”). The second computing device may need to be reconfigured with updated network credentials when at least one existing network credential for the network is updated/changed. The at least one network credential may be, for example, a new network name (e.g., Service Set Identifier) and/or a new network password.

At step 510, a first computing device (e.g., a network device) may receive updated network credentials. For example, the first computing device may receive an instruction that causes the first computing device to determine the updated network credentials. The instruction may be received from a client device. As another example, the first computing device may receive the updated network credentials directly from a client device that has administrative rights to first computing device. As a further example, the first computing device may determine the updated network credentials based on a network rule. The network rule may cause the first computing device to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The first computing device may be reconfigured with the new network credentials such that client devices may be required to provide the updated network credentials to the first computing device in order to access the network.

A second computing device, such as a client device, may lose communication with the network. The second computing device may have been previously configured to communicate with the network using network credentials that are no longer valid. The second computing device may attempt to rejoin the network by sending, to the first computing device, a request to join the network that comprises invalid network credentials. The first computing device may determine that second computing device attempted to rejoin the network using invalid network credentials. The first computing device may indicate to the second computing device that the network credentials provided with the request are not valid. The second computing device may begin listening for a reconfiguration message (e.g., a reconfiguration advertisement). For example, the second computing device may begin listening for the reconfiguration message in response to receiving the indication from the first computing device that the network credentials provided with the request are not valid. The second computing device may listen for the reconfiguration message using a first communications protocol. The first communications protocol may be a Bluetooth™ channel, a ZigBee channel, a Z-Wave channel, a near field communications (“NFC”) channel, or any suitable low-energy and/or short-range communications channel.

At step 520, the first computing device may send a reconfiguration message (e.g., a reconfiguration advertisement) to the second computing device via the first communications protocol. For example, the first computing device may generate a reconfiguration message (e.g., a reconfiguration advertisement) (e.g., one or more packets of data) that includes a configuration identifier previously generated by the first computing device during a prior configuration session and/or configuration data previously received by the first computing device during a prior configuration session. The configuration data may include a Uniform Resource Identifier (“URI”). The URI may represent a public key, a configuration channel, and/or a Media Access Control (“MAC”) address associated with the second computing device. The reconfiguration message may identify the second computing device via the MAC address identified by the configuration data. The first computing device may send the reconfiguration message to the second computing device via the configuration channel identified by the configuration data. The first computing device may send the reconfiguration message in response to a determination that the network credentials provided by the second computing device are not valid.

The second computing device may receive the reconfiguration message from the first computing device. When providing the reconfiguration message, the first computing device may hash the configuration identifier and/or the configuration data. For example, the first computing device may provide the reconfiguration message and a hash of the configuration identifier and/or a hash of the configuration data to the second computing device.

The second computing device may compare a result of hashing the configuration identifier previously provided by the first computing device to the hash of the configuration identifier and/or the hash of the configuration data sent by the first computing device with the reconfiguration message. In this way, the second computing device may receive the reconfiguration message and determine whether the sender of the reconfiguration message (e.g., the first computing device) is a trusted device.

The first computing device may generate a new configuration identifier (e.g., as part of a DPP C-sign-key and c-sign-key key pair) for the first computing device. The first computing device may generate the new configuration identifier in response to the sending the reconfiguration message (e.g., in response to beginning a reconfiguration process with the second computing device). The first computing device may send the new configuration identifier to the second computing device.

At step 530, the first computing device may receive a request to initiate a reconfiguration session from the second computing device via the first communications protocol. The first computing device may initiate the reconfiguration session with the second computing device. The reconfiguration session may be a DPP session. At step 540, the first computing device may send the updated network credentials to the second computing device via the first communications protocol. For example, the first computing device may send the updated network credentials to the second computing device during the reconfiguration session as part of a connector data structure.

At step 550, the first computing device may receive a further request to join the network from the second computing device via a second communications protocol. The second communications protocol may be an 802.11 channel, such as a WiFi channel. The second computing device may send the further request to join the network via the second communications protocol. The further request to join the network may include the updated network credentials. The first computing device may determine whether the updated network credentials sent by the second computing device are valid. The first computing device may provide the second computing device with access to the network when it is determined that the updated network credentials are valid.

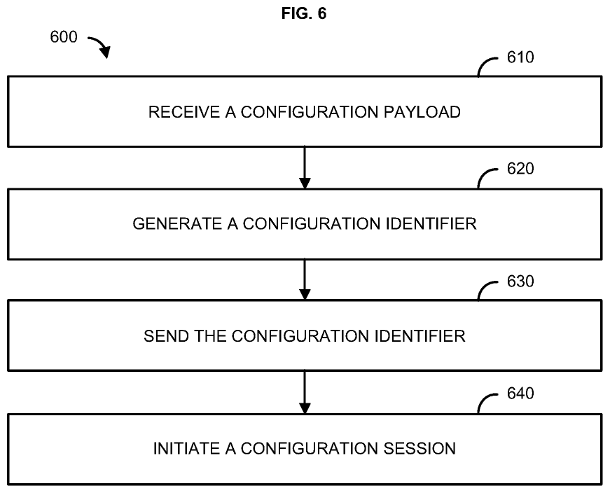

FIG. 6 is a flowchart illustrating an example method 600 for network management. The method 600 may be implemented using the devices of the system 100. For example, the method 600 may be implemented by a first computing device, such as the network device 102. The method 600 may be implemented by the first computing device when a second computing device, such as the client device 104, becomes capable of using device provisioning protocol (“DPP”). The second computing device may have been previously configured to communicate with a network generated by the first computing device using a legacy configuration technique. The second computing device may perform a software and/or firmware update to become DPP-capable. As part of the software and/or firmware update, the second computing device may receive and/or install DPP provisioning software.

At step 610, the first computing device may receive a configuration payload. The configuration payload may be received from the second computing device. The second computing device may send the configuration payload following a software and/or firmware update performed by the second computing device to become DPP-capable. The second computing device may receive and/or install DPP provisioning software and/or firmware when performing the software and/or firmware update. The software and/or firmware update may send a request for a configuration identifier to the first computing device. The request for the configuration identifier may be sent to the first computing device along with the configuration payload. As another example, the request for the configuration identifier may be sent to the first computing device separate from the configuration payload. The request for the configuration identifier may include configuration data, such as the identifier 111 of the client device 104. The configuration data may include a public key, a configuration channel, and/or a Media Access Control (“MAC”) address associated with the second computing device.

At step 620, the first computing device may generate a configuration identifier. The first computing device may generate the configuration identifier in response to receiving the configuration payload and/or the request for the configuration identifier from the second computing device. The first computing device may store the configuration identifier and/or the configuration payload in memory, such as the access control module 119. The configuration identifier may be associated with the first computing device.

At step 630, the first computing device may send the configuration identifier to the second computing device. The first computing device may also send the configuration data (e.g., a connector data structure) to second computing device. For example, the first computing device may generate a configuration package (e.g., one or more packets of data) that includes the configuration data and the configuration identifier. The configuration package may identify the second computing device via the MAC address identified by the configuration data. The first computing device may send the configuration package to the second computing device via the configuration channel identified by the configuration data. The configuration channel may be associated with a WiFi channel. At step 640, the first computing device may initiate a configuration session with the second computing device. The first computing device may provide network credentials to the second computing device during the configuration session. For example, the first computing device may send updated network credentials to the second computing device that replace existing network credentials stored at the second computing device. The network credentials may be provided as part of a connector data structure.

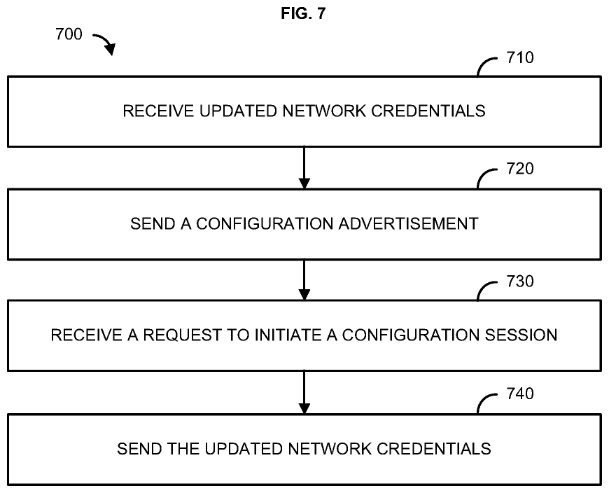

FIG. 7 is a flowchart illustrating an example method 700 for network management. The method 700 may be implemented using the devices of the system 100. For example, the method 700 may be implemented by a first computing device, such as the network device 102. The method 700 may be implemented by the first computing device when a second computing device needs to be reconfigured. The second computing device may be a client device that was previously configured (e.g., as part of the configuration process 200A or 200B) to communicate with a network generated by a first computing device. The second computing device may have been previously configured to communicate with the network using device provision protocol (“DPP”). The second computing device may need to be reconfigured with updated network credentials when at least one existing network credential for the network is updated/changed. The at least one network credential may be, for example, a new network name (e.g., Service Set Identifier) and/or a new network password.

At step 710, a first computing device (e.g., a network device) may receive updated network credentials. The updated network credentials may include, for example, a network name (e.g., Service Set Identifier) and a network password. For example, the first computing device may receive an instruction that causes the first computing device to determine the updated network credentials. The instruction may be received from a client device. As another example, the first computing device may receive the updated network credentials directly from a client device that has administrative rights to first computing device. As a further example, the first computing device may determine the updated network credentials based on a network rule. The network rule may cause the first computing device to determine the updated network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name and/or a new network password. The first computing device may regenerate (e.g., broadcast) the network such that client devices may be required to provide the updated network credentials to the first computing device in order to access the network.

A second computing device, such as a client device, may lose communication with the network. The second computing device may have been previously configured to communicate with the network using network credentials that are no longer valid. The second computing device may attempt to rejoin the network by sending, to the first computing device, a request to join the network including invalid network credentials. The first computing device may determine that the second computing device may be prevented from accessing the network generated by the first computing device without the updated network credentials. For example, the first computing device may determine that second computing device attempted to rejoin the network using invalid network credentials. The first computing device may indicate to the second computing device that the network credentials provided with the request are not valid. The second computing device may begin listening for a reconfiguration message (e.g., a reconfiguration advertisement). For example, the second computing device may begin listening for the reconfiguration message in response to receiving the indication from the first computing device that the network credentials provided with the request are not valid. The second computing device may listen for the reconfiguration message using a first communications protocol. The first communications protocol may be a Bluetooth™ channel, a ZigBee channel, a Z-Wave channel, a near field communications (“NFC”) channel, or any suitable low-energy and/or short-range communications channel.

At step 720, the first computing device may send a reconfiguration message (e.g., a reconfiguration advertisement) to the second computing device. For example, the first computing device may generate a reconfiguration message (e.g., a reconfiguration advertisement) (e.g., one or more packets of data) that includes a configuration identifier previously generated by the first computing device during a prior configuration session and/or configuration data previously received by the first computing device during a prior configuration session. The configuration data may include a Uniform Resource Identifier (“URI”). The URI may represent a public key, a configuration channel, and/or a Media Access Control (“MAC”) address associated with the second computing device. The reconfiguration message may identify the second computing device via the MAC address identified by the configuration data. The first computing device may send the reconfiguration message to the second computing device via the configuration channel identified by the configuration data. The first computing device may send the reconfiguration message via the first communications protocol. The first computing device may send the reconfiguration message in response to a determination that the network credentials provided by the second computing device are not valid.

The second computing device may receive the reconfiguration message from the first computing device. When providing the reconfiguration message, the first computing device may encrypt the configuration identifier and/or the configuration data. For example, the first computing device may provide the reconfiguration message and a hash of the configuration identifier and/or a hash of the configuration data to the second computing device.

The second computing device may have a private key stored in a configuration module that corresponds to the configuration data. The second computing device may use the private key that corresponds to the configuration data to decrypt the hash of the configuration data. The second computing device may have a private key stored in the configuration module that corresponds to the configuration identifier. The second computing device may use the private key that corresponds to the configuration identifier to decrypt the hash of the configuration identifier. In this way, the second computing device may receive the reconfiguration message and determine whether the sender of the reconfiguration message (e.g., the first computing device) is a trusted device. For example, the second computing device may determine that the first computing device is a trusted device based on the hash of the configuration identifier—once decrypted using the private key associated with the configuration identifier—including the configuration identifier. As another example, the second computing device may determine that the first computing device is a trusted device based on the hash of the configuration data—once decrypted using the private key associated with the configuration data—including the configuration data.

The first computing device may generate a new configuration identifier (e.g., as part of a DPP C-sign-key and c-sign-key key pair) for the first computing device. The first computing device may generate the new configuration identifier in response to the sending the reconfiguration message (e.g., in response to beginning a reconfiguration process with the second computing device). The first computing device may send the new configuration identifier to the second computing device. The second computing device may generate a new private key associated with the new configuration key. The second computing device may store the new private key in the configuration module.

At step 730, the first computing device may receive a request to initiate a reconfiguration session from the second computing device. The first computing device may initiate the reconfiguration session with the second computing device. The reconfiguration session may be a DPP session. At step 740, the first computing device may send the updated network credentials to the second computing device. For example, the first computing device may send the updated network credentials to the second computing device during the reconfiguration session via the first communications protocol. The first computing device may receive a further request to join the network from the second computing device. The second computing device may send the further request to join the network via the second communications protocol (e.g., via WiFi). The further request to join the network may include the updated network credentials. The first computing device may determine whether the updated network credentials sent by the second computing device are valid. The first computing device may provide the second computing device with access to the network when it is determined that the updated network credentials are valid.

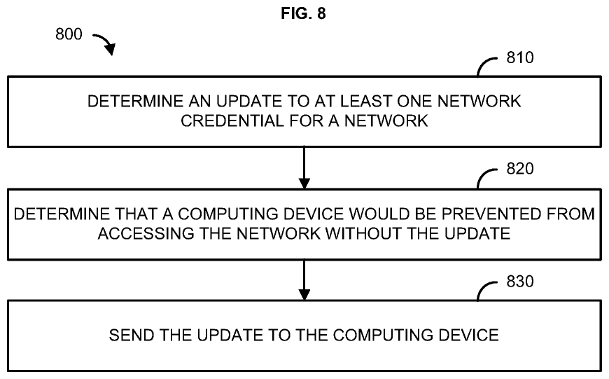

Turning now to FIG. 8, a flowchart illustrating an example method 800 for network management is shown. The method 800 may be implemented using the devices of the system 100. For example, the method 800 may be implemented by a first computing device, such as the network device 102. The method 800 may be implemented by the first computing device when a second computing device needs to be reconfigured. The second computing device may be a client device that was previously configured (e.g., as part of the configuration process 200A or 200B) to communicate with a network generated by a first computing device. The second computing device may have been previously configured to communicate with the network (e.g., using device provision protocol (“DPP”)). The second computing device may need to be reconfigured with updated network credentials when at least one existing network credential for the network is updated/changed. The at least one network credential may be, for example, a new network name (e.g., Service Set Identifier) and/or a new network password.

At step 810, the first computing device may determine an update to at least one network credential. The at least one network credential may include, for example a service set identifier for a network generated by the first computing device and/or a password for the network. The first computing device may provide access to the network based on the at least one network credential. The first computing device may receive an instruction that causes the first computing device to determine the update to the at least one network credential. The instruction may be received from a user device. As another example, the first computing device may receive the instruction directly from a user device that has administrative rights to the first computing device. As a further example, the first computing device may determine the update to the at least one network credential based on a network rule. The network rule may cause an access control module of the first computing device to determine the update to the at least one network credential at a specific date and/or time (e.g., a date and/or time defined by the network rule) or after a specific duration of time has elapsed (e.g., a quantity of hours, days, months, etc., defined by the network rule). The update to the at least one network credential may include, for example, a new network name and/or a new network password. The first computing device may use a communications module to regenerate (e.g., broadcast) the network such that computing devices (e.g., client devices) may be required to provide the updated at least one network credential to the first computing device in order to access the network.

At step 820, the first computing device may determine that the second computing device may be prevented from accessing the network generated by the first computing device without the update to the at least one network credential. For example, the first computing device may determine that second computing device attempted to rejoin the network using invalid network credentials. The first computing device may indicate to the client device that the network credentials provided with the request are not valid. The first computing device may send a reconfiguration message (e.g., a reconfiguration advertisement) to the second computing device. For example, the first computing device may use a configuration module to generate a reconfiguration message (e.g., a reconfiguration advertisement) (e.g., one or more packets of data) that includes a configuration identifier previously generated by the first computing device during a prior configuration session and/or an identifier previously received by the first computing device during a prior configuration session. The reconfiguration message may identify the second computing device via a MAC address identified by the identifier. The first computing device may send the reconfiguration message to the second computing device via a configuration channel identified by the identifier. The first computing device may send the reconfiguration message via a first communications protocol (e.g., a low-energy communications protocol). The first computing device may send the reconfiguration message in response to a determination that the network credentials provided by the second computing device are not valid.

The second computing device may receive the reconfiguration message from the first computing device. When providing the reconfiguration message, the first computing device may encrypt the configuration identifier. For example, the first computing device may provide the reconfiguration message and a hash of the configuration identifier to the second computing device. The second computing device may receive the reconfiguration message and the hash of the configuration identifier using a communications module. The second computing device may have a private key stored in the configuration module that corresponds to the identifier. The second computing device may use the private key that corresponds to the configuration identifier to decrypt the hash of the identifier. The second computing device may have a private key stored in the configuration module that corresponds to the configuration identifier. The second computing device may use the private key that corresponds to the configuration identifier to decrypt the hash of the configuration identifier. In this way, the second computing device may receive the reconfiguration message (e.g., along with the hash of the configuration identifier) and determine whether the sender of the reconfiguration message (e.g., the first computing device) is a trusted device. For example, the second computing device may determine that the first computing device is a trusted device based on the hash of the configuration identifier—once decrypted using the private key associated with the configuration identifier—including the configuration identifier.

The first computing device may generate a new configuration identifier (e.g., as part of a DPP C-sign-key and c-sign-key key pair). The new configuration identifier may be stored in the access control module of the first computing device. The first computing device may generate the new configuration identifier in response to sending the reconfiguration message (e.g., in response to beginning a reconfiguration process with the second computing device). The first computing device may send the new configuration identifier to the second computing device. The second computing device may receive the new configuration identifier and store it in the configuration module. The second computing device may use the configuration module to generate a new private key associated with the new configuration key. The second computing device may store the new private key in the configuration module.

The first computing device may initiate a reconfiguration session with the second computing device. Additionally, or in the alternative, the second computing device may send a request to initiate the reconfiguration session to the first computing device. The reconfiguration session may be a DPP session. At step 830, the first computing device may send the update to the at least one network credential to the second computing device (e.g., during the reconfiguration session). For example, the first computing device may send the update to the at least one network credential to the second computing device during the reconfiguration session via the first communications protocol. The first computing device may receive a further request to join the network from the second computing device. The second computing device may send the further request to join the network via a second communications protocol (e.g., via WiFi). The further request to join the network may include the updated at least one network credential. The first computing device may determine whether the at least one network credential sent by the second computing device is/are valid. The first computing device may provide the second computing device with access to the network when it is determined that the at least one network credential is/are valid.

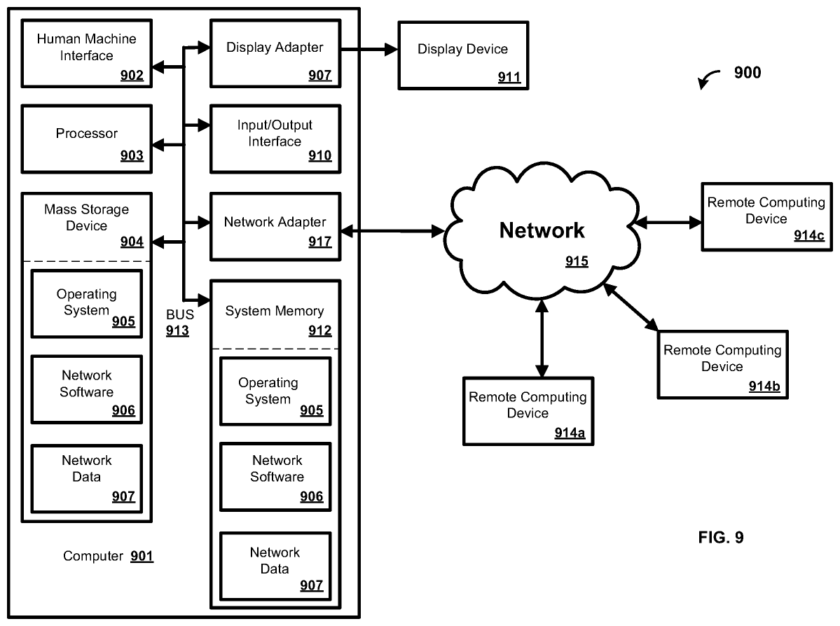

FIG. 9 is a block diagram illustrating an exemplary operating environment 900 for performing the methods described herein. In an exemplary example, the methods and systems of the present description can be implemented on a computer 901 as illustrated in FIG. 9 and described below. By way of example, each of the devices of FIG. 1 may be a computer 901 as illustrated in FIG. 9. Similarly, the methods and systems described can utilize one or more computing devices to perform one or more functions in one or more locations. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and/or the like.

The processing of the described methods and systems can be performed by software components. The described systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The described methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods described herein can be implemented via a general-purpose computing device in the form of a computer 901. The components of the computer 901 can comprise, but are not limited to, one or more processors 903, a system memory 912, and a system bus 913 that couples various system components including the processor 903 to the system memory 912. In the case of multiple processors 903, the system can utilize parallel computing.

The system bus 913 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and each of the subsystems, including the processor 903, a mass storage device 904, an operating system 905, network software 906, network data 907, a network adapter 917, system memory 912, an Input/Output Interface 910, a display adapter 909, a display device 911, and a human machine interface 902, can be contained within one or more remote computing devices 914a,b,c at physically separate locations, connected through buses of this form, in effect implementing a fully distributed system.

The computer 901 typically includes a variety of computer readable media. Exemplary readable media can be any available media that is accessible by the computer 901 and includes, for example and not meant to be limiting, both volatile and non-volatile media, removable and non-removable media. The system memory 912 includes computer readable media in the form of volatile memory, such as random access memory (RAM), and/or non-volatile memory, such as read only memory (ROM). The system memory 912 typically contains data, such as network data 907, and/or program modules, such as operating system 905 and network software 906, that are immediately accessible to and/or are presently operated on by the processor 903.

In another example, the computer 901 can also comprise other removable/non-removable, volatile/non-volatile computer storage media. By way of example, FIG. 9 illustrates a mass storage device 904 which can provide non-volatile storage of computer code, computer readable instructions, data structures, program modules, and other data for the computer 901. For example and not meant to be limiting, a mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, an operating system 905 and network software 906 (e.g., to encrypt/decrypt network credentials, generate a network, send/receive data to/from an access point, etc.). Each of the operating system 905 and network software 906 (or some combination thereof) can comprise elements of the programming and the network software 906. The network data 907 (e.g., configuration data, public key(s), private key(s), routing table(s), network credentials, etc.) can also be stored on the mass storage device 904. The network data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another example, the user can enter commands and information into the computer 901 via an input device (not shown). Examples of such input devices comprise, but are not limited to, a keyboard, pointing device (e.g., a “mouse”), a microphone, a joystick, a scanner, tactile input devices, such as gloves, and other body coverings, and the like. These and other input devices can be connected to the processor 903 via a human machine interface 902 that is coupled to the system bus 913, but can be connected by other interface and bus structures, such as a parallel port, game port, an IEEE 1394 Port (also known as a Firewire port), a serial port, or a universal serial bus (USB).

In yet another example, a display device 911 can also be connected to the system bus 913 via an interface, such as a display adapter 909. It is contemplated that the computer 901 can have more than one display adapter 909 and the computer 901 can have more than one display device 911. For example, a display device can be a monitor, an LCD (Liquid Crystal Display), or a projector. In addition to the display device 911, other output peripheral devices can comprise components, such as speakers (not shown) and a printer (not shown) which can be connected to the computer 901 via Input/Output Interface 910. Any step and/or result of the methods can be output in any form to an output device. Such output can be any form of visual representation, including, but not limited to, textual, graphical, animation, audio, tactile, and the like. The display 911 and computer 901 can be part of one device, or separate devices.

The computer 901 can operate in a networked environment using logical connections to one or more remote computing devices 914a,b,c. By way of example, a remote computing device can be a personal computer, portable computer, smartphone, a server, a router, a network computer, a peer device or other common network node, and so on. Logical connections between the computer 901 and a remote computing device 914a,b,c can be made via a network 915, such as a local area network (LAN) and/or a general wide area network (WAN). Such network connections can be through a network adapter 917. A network adapter 917 can be implemented in both wired and wireless environments. Such networking environments are conventional and commonplace in dwellings, offices, enterprise-wide computer networks, intranets, and the Internet.

For purposes of illustration, application programs and other executable program components, such as the operating system 905 are illustrated herein as discrete blocks, although it is recognized that such programs and components reside at various times in different storage components of the computing device 901, and are executed by the data processor(s) of the computer. An implementation of network software 906 can be stored on or transmitted across some form of computer readable media. Any of the described methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information, such as computer readable instructions, data structures, program modules, or other data. Exemplary computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice described herein. It is intended that the specification and examples be considered as exemplary only, with a true scope and spirit being indicated by the following claims.

What is claimed is:

1. A method comprising
determining, by a first computing device, an update to at least one network credential, wherein the first computing device provides access to a network based on the at least one network credential;
determining, based on the update, a second computing device that would be prevented from accessing the network without the update; and
sending, via a configuration session between the first computing device and the second computing device, and by the first computing device and to the second computing device, the update to the at least one network credential.

2. The method of claim 1, further comprising:
receiving, by the first computing device from a third computing device, the update to the at least one network credential, wherein the third computing device is a user device associated with administrative rights to the first computing device.

3. The method of claim 1, wherein the second computing device is provisioned to communicate with the first computing device via a device provisioning protocol session and a user device in communication with the first computing device.

4. The method of claim 1, wherein the at least one network credential comprises a service set identifier or a password.

5. The method of claim 1, wherein the second computing device, prior to receiving the update to the at least one network credential, would be prevented by the first computing device from accessing the network using the at least one network credential.

6. The method of claim 1, wherein the wherein the second computing device, based on the received update to the at least one network credential, is configured to access the network using the at least one network credential.

7. The method of claim 1, further comprising:
receiving, by the second computing device, a configuration advertisement;
determining, by the second computing device, that the configuration advertisement originated from the first computing device; and
sending, to the first computing device, a request to initiate the configuration session.

8. A method comprising
receiving, by a first computing device from a second computing device, a configuration advertisement, wherein the second computing device sends the configuration advertisement based on an update to at least one network credential;
sending, to the second computing device based on the configuration advertisement, a request to initiate a configuration session between the first computing device and the second computing device;
receiving, via the configuration session, the update to the at least one network credential; and
sending, to the second computing device, a request to join a network provided by the second computing device, wherein the request comprises the at least one network credential.

9. The method of claim 8, further comprising:
receiving, by the second computing device from a third computing device, the update to the at least one network credential, wherein the third computing device is a user device associated with administrative rights to the second computing device.

10. The method of claim 8, wherein the first computing device, prior to receiving the update to the at least one network credential, would be prevented by the second computing device from accessing the network using the at least one network credential.

11. The method of claim 8, wherein the configuration session is a device provisioning protocol session.

12. The method of claim 8, wherein the first computing device is provisioned to communicate with the second computing device via a device provisioning protocol session and a user device in communication with the second computing device.

13. The method of claim 8, wherein the at least one network credential comprises a service set identifier or a password.

14. The method of claim 8, wherein the configuration advertisement comprises a configuration identifier provided by the second computing device to the first computing device via a prior configuration session.

15. A method comprising
determining, by a first computing device, updated network credentials, wherein the first computing device is configured to generate a network accessible via the updated network credentials;
receiving, from a second computing device, a configuration advertisement;
sending, to the second computing device based on the configuration advertisement, a request to initiate a configuration session; and
sending, via the configuration session, the updated network credentials to the second computing device.

16. The method of claim 15, further comprising:
initiating the configuration session with the second computing device, wherein the configuration session is a device provisioning protocol session.

17. The method of claim 15, wherein the second computing device is provisioned to communicate with the first computing device via a device provisioning protocol session and a user device in communication with the first computing device.

18. The method of claim 15, wherein the second computing device sends the configuration advertisement to the first computing device based on an unsuccessful attempt to join the network using invalid network credentials.

19. The method of claim 15, wherein the configuration advertisement comprises a hash of a configuration identifier.

20. The method of claim 19, further comprising:
determining, by the first computing device based on the hash of the configuration identifier, that the configuration advertisement originated from the second computing device.
